(19) United States
(12) Patent Application Publication
(10) Pub. No.: US 2008/0189118 A1
(43) Pub. Date: Aug. 7, 2008

(54) AUDIO ENCODING AND DECODING APPARATUS AND METHOD THEREOF

(75) Inventors: Geon-hyoung LEE, Hwanseong-si (KR); Jae-one Oh, Yongin-si (KR); Chul-woo Lee, Suwon-si (KR); Jong-hoon Jeong, Suwon-si (KR); Nam-suk Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/024,381

(22) Filed: Feb. 1, 2008

(30) Foreign Application Priority Data
Feb. 1, 2007 (KR) 10-2007-0010676

(51) Int. Cl. G10L 19/00

(52) U.S. Cl. 704/500; 704/E21.001

(57) ABSTRACT

An audio encoding and decoding apparatus and a method thereof, capable of improving compression efficiency, by using coefficients that are stable over a period of time and in a range of frequency bands, are provided. The audio encoding method divides an input audio signal into frames having lengths different from each other; obtaining at least one magnitude in relation to each of the frames having different lengths; and encoding the magnitude. The audio decoding method separates at least one encoded magnitude in relation to each of frames having different lengths, based on the frame length; decoding each of the separated encoded magnitudes; and restoring an audio signal by using the decoded magnitude.

### CROSS-REFERENCE TO RELATED PATENT APPLICATIONS

This application claims priority of Korean Patent Application No. 10-2007-0010676, filed on Feb. 1, 2007 in the Korean Intellectual Property Office, the disclosure of which is incorporated herein in its entirety by reference.

### BACKGROUND OF THE INVENTION

1. Field of the Invention

Apparatuses and methods consistent with the present invention relate to an audio encoding and decoding, and more particularly, to an audio encoding and decoding which are capable of improving compression efficiency.

2. Description of the Related Art

Most related art audio encoding apparatuses use a time-frequency transform encoding method. In this type of encoding method, an input audio signal is encoded by using modified discrete cosine transformation (MDCT). In the MDCT method, an MDCT coefficient obtained by transforming an input audio signal into the frequency domain is encoded. However, since the MDCT coefficient obtained by the MDCT method relies on phase, the MDCT coefficient becomes very unstable over time and frequency bands. That is, since the MDCT coefficient is a cosine component of a component forming sound, the MDCT coefficient is a variable in which a phase component is added to the amplitude of the component forming sound. Accordingly, since the MDCT coefficient is difficult to predict a phase, the MDCT coefficient becomes very unstable over the time and frequency bands, and an audio encoding apparatus based on the MDCT requires a large number of bits to be encoded, thereby lowering compression efficiency.

### SUMMARY OF THE INVENTION

Exemplary embodiments of the present invention overcome the above disadvantages and other disadvantages not described above. The present invention provides an audio encoding and decoding apparatus and a method thereof, capable of improving compression efficiency, by using coefficients that are stable over time and frequency bands.

The present invention also provides an audio encoding and decoding apparatus and a method thereof, capable of improving compression efficiency, by encoding the magnitude of a frame having a length that is different to that of other frames.

According to an aspect of the present invention, there is provided an audio encoding method comprising: dividing an input audio signal into frames having lengths different from each other; obtaining at least one magnitude in relation to each of the frames having different lengths; and encoding the magnitude.

The obtaining of the at least one magnitude in relation to each of the frames may include: performing Fourier transformation on each of the frames having different lengths; determining a Fourier transform coefficient from the Fourier transformed signal; and obtaining the at least one magnitude from the Fourier transform coefficients.

The method may further include: obtaining the phase of a short frame from among the frames having different lengths; calculating the phase difference between the phase of the short frame and the phase of the previous short frame; generating a parameter based on the phase difference; and encoding the parameter, wherein the parameter indicates whether the phase difference is negative.

The method may further include: predicting at least one magnitude of each of the frames having different lengths; and determining the difference between the at least one predicted magnitude and the at least one obtained magnitude, wherein in the encoding of the magnitude, the difference between the magnitudes, instead of the magnitude, is encoded.

According to another aspect of the present invention, there is provided an audio decoding method comprising: separating at least one encoded magnitude in relation to each of frames having different lengths, based on the frame length; decoding each of the separated encoded magnitudes; and restoring an audio signal using the decoded magnitude.

The restoring of the audio signal may include: calculating the phase difference between a current short frame and a previous short frame of the short frame from among the frames having different lengths; detecting the phase of the current short frame based on the calculated phase difference; and restoring the audio signal by using the phase of the current short frame and the decoded magnitude of the short frame.

The method may further include: decoding a parameter received together with the encoded magnitude of each of the frames having different lengths, wherein in the detecting of the phase of the current short frame, the phase of the current short frame is detected by further using the decoded parameter, and the parameter indicates whether the phase difference between the current short frame and the previous short frame is a negative.

The method may further include predicting at least one magnitude of each of the frames having different lengths, wherein the phase difference between the current short frame and the previous short frame is calculated by using the sum of the at least one predicted magnitude of each of the frames and the decoded magnitude of each of the frames having different lengths, as the decoded magnitude.

According to another aspect of the present invention, there is provided an audio encoding apparatus including: a first segmentation unit dividing an input audio signal into short frames; a first magnitude detection unit obtaining at least one magnitude of a short frame output from the first segmentation unit; a second segmentation unit dividing the input audio signal into long frames; a second magnitude detection unit obtaining at least one magnitude of a long frame output from the second segmentation unit; and an encoding unit encoding the magnitudes detected by the first magnitude detection unit and the second magnitude detection unit, wherein the length of the short frame is different from the length of the long frame.

The length of a long frame may be twice the length of a short frame, and the contents of the long frame may correspond to the contents of a current short frame and a previous short frame of the short frame.

According to another aspect of the present invention, there is provided an audio decoding apparatus comprising: a separation unit separating at least one encoded magnitude of each of frames having different lengths, based on the frame length; a first decoding unit decoding the magnitude of a short frame separated by the separation unit; a second decoding unit decoding the magnitude of a long frame separated by the separation unit; and a restoration unit restoring an audio signal, by using the magnitude of the short frame decoded in the first decoding unit and the magnitude of the long frame decoded in the second decoding unit.

The restoration unit may include: a phase difference calculator calculating the phase difference between a current short frame and a previous short frame of the short frame, by using the decoded magnitude of the short frame, the decoded magnitude of the long frame, and the decoded magnitude of the previous short frame; a phase detector detecting the phase of the current short frame based on the phase difference; and an audio signal restorer restoring the audio signal by using the phase of the current short frame and the magnitude of the short frame decoded in the first decoding unit.

### BRIEF DESCRIPTION OF THE DRAWINGS

The above and other features and advantages of the present invention will become more apparent by describing in detail exemplary embodiments thereof with reference to the attached drawings:

FIG. 1 is a functional block diagram illustrating an audio encoding apparatus according to an exemplary embodiment of the present invention;

FIG. 2 is a diagram illustrating an example of a relationship between a short frame output from a first segmentation unit illustrated in FIG. 1 and a long frame output from a second segmentation unit illustrated in FIG. 1 according to an exemplary embodiment of the present invention;

FIG. 3 is a functional block diagram illustrating an audio encoding apparatus according to another exemplary embodiment of the present invention;

FIG. 4 is a functional block diagram illustrating an audio encoding apparatus according to still another exemplary embodiment of the present invention;

FIG. 5 is a functional block diagram illustrating an audio decoding apparatus according to an exemplary embodiment of the present invention;

FIG. 6 is a functional block diagram illustrating an audio decoding apparatus according to another exemplary embodiment of the present invention;

FIG. 7 is a functional block diagram illustrating an audio decoding apparatus according to still another exemplary embodiment of the present invention;

FIG. 8 is a flowchart illustrating an audio encoding method according to an exemplary embodiment of the present invention;

FIG. 9 is a detailed flowchart of a process of obtaining the magnitude of each frame, illustrated in FIG. 8, according to an exemplary embodiment of the present invention;

FIG. 10 is a flowchart illustrating an audio encoding method according to another exemplary embodiment of the present invention;

FIG. 11 is a flowchart illustrating an audio encoding method according to still another exemplary embodiment of the present invention;

FIG. 12 is a flowchart illustrating an audio decoding method according to an exemplary embodiment of the present invention;

FIG. 13 is a flowchart illustrating an audio decoding method according to another exemplary embodiment of the present invention; and

FIG. 14 is a flowchart illustrating an audio decoding method according to still another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

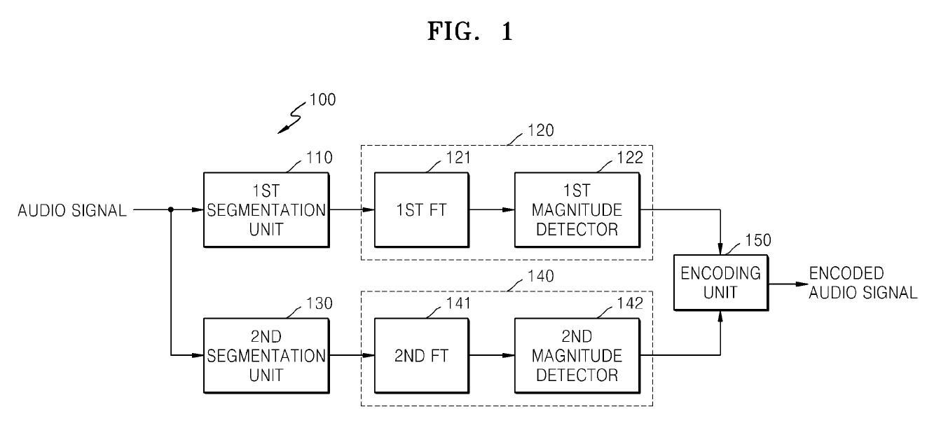

FIG. 1 is a functional block diagram illustrating an audio encoding apparatus according to an exemplary embodiment of the present invention.

Referring to FIG. 1, the audio encoding apparatus 100 includes a first segmentation unit 110, a first magnitude detection unit 120, a second segmentation unit 130, a second magnitude detection unit 140, and an encoding unit 150.

The first segmentation unit 110 divides an input audio signal into short frames each having a predetermined length N.

The first magnitude detection unit 120 obtains at least one magnitude in relation to the short frame output from the first segmentation unit 110. In order to obtain this magnitude, the first magnitude detection unit 120 includes a first Fourier transformer (FT) 121 and a first magnitude detector 122.

The first Fourier transformer 121 performs Fourier transformation on the input short frame signal. The Fourier transformation can be performed as one of discrete Fourier transformation (DFT) and fast Fourier transformation (FFT). The short frame signal Sₛₕₒᵣₜ which is output from the first Fourier transformer 121 after being Fourier transformed, can be defined as given by equation 1 below:

$${S}_{short} = {\sum }_{ω = 0}^{N / 2 - 1} {a}_{ω} cos ( ω t ) + {b}_{ω} sin ( ω t ) \qquad ( 1 )$$

Equation 1 is obtained by Fourier transformation based on continuous time. The DFT is Fourier transformation based on discontinuous time. If the short frame signal Sₛₕₒᵣₜ is defined based on the DFT, it is defined the same as equation 1 except a case when ω equals 0. That is, when the short frame signal Sₛₕₒᵣₜ is defined based on the DFT, it is defined to be different from equation 1 when ω equals 0.

The first magnitude detector 122 determines Fourier transform coefficients a_{ω} and b_{ω} from a short frame signal output from the first Fourier transformer 121.

The first magnitude detector 122 determines at least one magnitude from the detected Fourier transform coefficients a_{ω} and b_{ω}. That is, the first magnitude detector 122 can define the Fourier transform coefficients a_{ω} and b_{ω} in complex number form as a_{ω}+i·b_{ω}. The first magnitude detector 122 can obtain a magnitude r_{ω}, by performing polar transformation on the complex number a_{ω}+i·b_{ω}, as given by equation 2 below:

r_{ω}=sqrt(a_{ω}²+b_{ω}²) (2)

In this exemplary embodiment, a N/2 magnitudes in relation to one short frame are detected. The N/2 magnitudes detected by the first magnitude detector 122 are transmitted to the encoding unit 150.

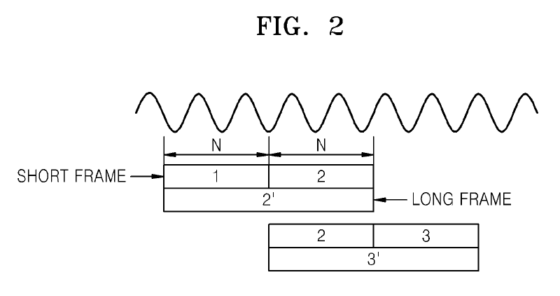

Meanwhile, the second segmentation unit 130 divides an input audio signal into long frames which each have a predetermined length 2N. Accordingly, the short frame output from the first segmentation unit 110 and the long frame output from the second segmentation unit 130 have a relationship as illustrated in FIG. 2.

FIG. 2 is a diagram illustrating an example of a relationship between a short frame output from the first segmentation unit 110 illustrated in FIG. 1 and a long frame output from the second segmentation unit 130 illustrated in FIG. 1 according to an exemplary embodiment of the present invention. Referring to FIG. 2, it can be determined that the contents of the second long frame (2′) output from the second segmentation unit 130 corresponds to the contents of the first short frame (1) and the second short frame (2) output from the first segmentation unit 110. Also, it can be determined that the contents of the third long frame (3′) output from the second segmentation unit 130 corresponds to the contents of the second short frame (2) and the third short frame (3) output from the first segment unit 110. Accordingly, a long frame output from the second segmentation unit 130 has a length that is twice the length of a short frame output from the first segmentation unit 110.

The second magnitude detection unit 140 obtains at least one magnitude in relation to a long frame output from the second segmentation unit 130. For this, the second magnitude detection unit 140 includes a second FT 141 and a second magnitude detector 142. The second FT 141 performs Fourier transformation on a long frame signal input in the same manner as the first FT 121. Accordingly, the Fourier transformed long frame signal output from the second FT 141 can be defined as given by equation 3 below:

$${S}_{long} = {\sum }_{ω = 0}^{N / 2 - 1} {a}_{ω} cos ( ω t ) + {b}_{ω} sin ( ω t ) \qquad ( 3 )$$

The second magnitude detector 142 determines Fourier transform coefficients a_{ω} and b_{ω} from the Fourier transformed long frame signal output from the second FT 141 in the same manner as the first magnitude detector 122. The second magnitude detector 142 determines at least one magnitude from the detected Fourier transform coefficients a_{ω} and b_{ω}. That is, the second magnitude detector 142 can define the Fourier transform coefficients a_{ω} and b_{ω} in complex number form as a_{ω}+i·b_{ω}. The second magnitude detector 142 obtains N magnitudes (R_{ω}), by performing polar transformation on the complex number a_{ω}+i·b_{ω}, as given by equation 4 below:

sqrt(a_{ω}²+b_{ω}²) (4)

Then, the second magnitude detector 142 outputs, as a detected magnitude, the magnitude (R_{2ω}) of even frequencies defined as given by equation 5 below:

R_{2ω}=sqrt(a_{2ω}²+b_{2ω}²) (5)

As described above, detection of the magnitude (R_{2ω}) of the even frequencies is performed because the coefficients of Fourier transformed signals of a current short frame and the previous short frame and the coefficient of the Fourier transformed signal of the long frame have a relationship as given by equation 6 below:

R_{2ω} cos Φ_{2ω}=r_{ω} cos φ_{ω}+\tilde{r}_{ω} cos \tilde{φ}_{ω}

R_{2ω} sin Φ_{2ω}=r_{ω} sin φ_{ω}+\tilde{r}_{ω} sin \tilde{φ}_{ω} (6)

That is, when performing Fourier transformation of a long frame, since a basis vector (cos Φ_{2ω}, sin Φ_{2ω}) having an even-number frequency can be defined as being the same as the result of connecting the basis vector (cos φ_{ω}, sin φ_{ω}) of the current short frame and the basis vector (cos \tilde{φ}_{ω}, sin \tilde{φ}_{ω}) of the previous short frame, and therefore, the second magnitude detector 142 determines the magnitudes (R_{2ω}) of N/2 even frequencies from the Fourier transformed long frame signal output from the second FT 141. In equation 6, \tilde{r}_{ω} is the magnitude of the previous short frame and cos \tilde{φ}_{ω} and sin \tilde{φ}_{ω} are the basis vector of the previous short frame.

The encoding unit 150 encodes the N/2 magnitudes (r_{ω}) output from the first magnitude detector 120, and the N/2 magnitudes (R_{2ω}) output from the second magnitude detector 140, and outputs the results of the encoding as an encoded audio signal. The encoded audio signal can be output in the form of a bitstream.

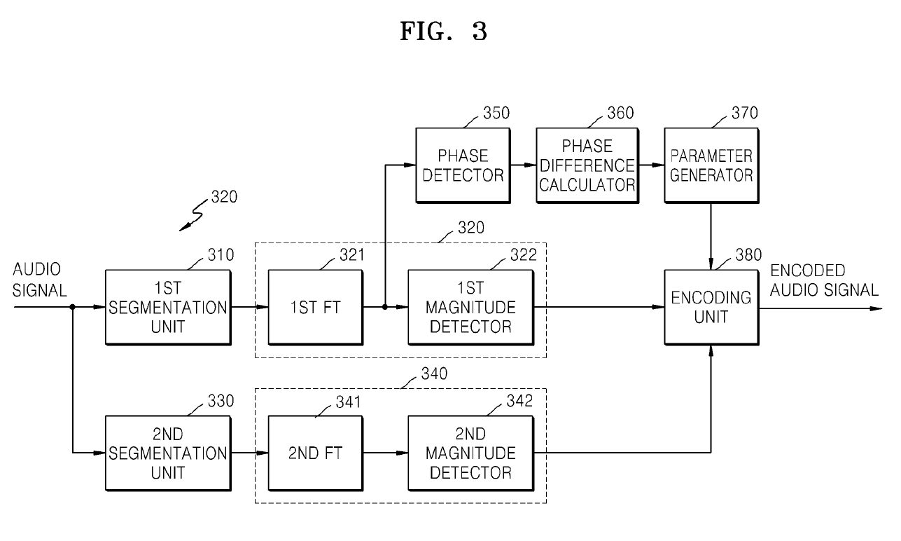

FIG. 3 is a functional block diagram illustrating an audio encoding apparatus 300 according to another exemplary embodiment of the present invention.

Referring to FIG. 3, the audio encoding apparatus 300 includes a first segmentation unit 310, a first magnitude detection unit 320, a second segmentation unit 330, a second magnitude detection unit 340, a phase detector 350, a phase difference detector 360, a parameter generator 370, and an encoding unit 380.

The first segmentation unit 310, the first magnitude detection unit 320, the second segmentation unit 330, and the second magnitude detection unit 340 illustrated in FIG. 3 are constructed and operate in a manner similar to that of the first segmentation unit 110, the first magnitude detection unit 120, the second segmentation unit 130, and the second magnitude detection unit 140. Accordingly, a first FT 321 and a first magnitude detector 322 included in the first magnitude detection unit 320 are constructed and operate in a manner similar to that of the first FT 121 and the first magnitude detector 122, respectively, illustrated in FIG. 1, and a second FT 341 and a second magnitude detector 322 included in the second magnitude detection unit 340 are constructed and operate in a manner similar to that of the second FT 141 and the second magnitude detector 142, respectively, illustrated in FIG. 1.

The phase detector 350 determines Fourier transform coefficients a_{ω} and b_{ω} from a Fourier transformed short frame signal as defined by equation 1 output from the first FT 321. The phase detector 350 determines the phase of the short frame from the detected Fourier transform coefficients a_{ω} and b_{ω}. That is, the phase detector 350 can define the Fourier transform coefficient a_{ω} and b_{ω} in the form of a complex number a_{ω}+i·b_{ω}. The phase detector 350 determines the phase (φ) as given by equation 7 below, by performing polar transformation on the complex number a_{ω}+i≮b_{ω}:

φ=arg(a_{ω}+i·b_{ω}) (7)

The phase detector 350 can be implemented so that the phase detector 350 receives the Fourier transform coefficients a_{ω} and b_{ω} from the first magnitude detector 322, and can detect the phase (φ) of a short frame, by performing polar transformation on a complex number as described above.

The phase difference calculator 360 calculates the phase difference (φ_{ω}−\tilde{φ}_{ω}) between the phase (φ) detected by the phase detector 350 and the phase (\tilde{φ}_{ω}) of the previous short frame. After the phase difference (φ_{ω}−\tilde{φ}_{ω}) is calculated, the phase difference calculator 360 stores the phase (φ) of the current short frame so that the phase (φ) can be used when the phase difference of a next short frame is calculated.

The parameter generator 370 generates a parameter indicating whether the phase difference (φ_{ω}−\tilde{φ}_{ω}) is a positive or negative. That is, if the phase difference (φ_{ω}−\tilde{φ}_{ω}) is received, the parameter generator 370 checks whether the received phase difference (φ_{ω}−\tilde{φ}_{ω}) satisfies a condition −π<φ_{ω}−\tilde{φ}_{ω}<π. If the received phase difference (φ_{ω}−\tilde{φ}_{ω}) does not satisfy the condition −π<φ_{ω}−\tilde{φ}_{ω}<π, the parameter generator 370 adds 2π to or subtracts 2π from the phase (\tilde{φ}_{ω}) of the previous short frame, and then, generates the obtained sign as a parameter.

For example, if φ=3π and \tilde{φ}_{ω}=0.5π, φ_{ω}−\tilde{φ}_{ω}=2.5π. Accordingly, since the phase difference (φ_{ω}−\tilde{φ}_{ω}) does not satisfy the condition −π<φ_{ω}−\tilde{φ}_{ω}<π, the parameter generator 370 subtracts 2π from the phase (\tilde{φ}_{ω}) of the previous short frame so that the condition can be satisfied. As a result, φ_{ω}−\tilde{φ}_{ω}=0.5π is obtained, and the sign is (+). Accordingly, the parameter generator 370 generates a parameter indicating that the sign is not negative. Meanwhile, when the received phase difference (φ_{ω}−\tilde{φ}_{ω}) does not satisfy the condition −π<φ_{ω}−\tilde{φ}_{ω}<π, and the result of adding 2π to or subtracting 2π from the phase (\tilde{φ}_{ω}) of the previous short frame, as described above, is a negative (−), the parameter generator 370 generates a parameter indicating a negative.

Also, even when the received phase difference (φ_{ω}−\tilde{φ}_{ω}) satisfies the condition −π<φ_{ω}−\tilde{φ}_{ω}<π, a parameter indicating whether the sign of the phase difference satisfying the condition is a negative sign is generated. For example, if φ=π and \tilde{φ}_{ω}=1.5π, φ_{ω}−\tilde{φ}_{ω}=−0.5π. Accordingly, since the phase difference (φ_{ω}−\tilde{φ}_{ω}) satisfies the condition −π<φ_{ω}−\tilde{φ}_{ω}<π, and the sign is negative (−), the parameter generator 370 generates a parameter indicating that the phase difference is a negative. Meanwhile, if φ=π and \tilde{φ}_{ω}=0.5π, φ_{ω}−\tilde{φ}_{ω}=0.5π. Accordingly, since the phase difference (φ_{ω}−\tilde{φ}_{ω}) satisfies the condition −π<φ_{ω}−\tilde{φ}_{ω}<π, and the sign is positive, the parameter generator 370 generates a parameter indicating that the phase difference is not negative.

The generator parameter is then transmitted to the encoding unit 380.

The encoding unit 380 encodes the N/2 magnitudes of the short frame transmitted by the first magnitude detection unit 320, the N/2 magnitudes of the long frame transmitted by the second magnitude detection unit 340, and the parameter described above, respectively, and outputs the result of encoding as an encoded audio signal. The encoded audio signal may be in the form of a bitstream.

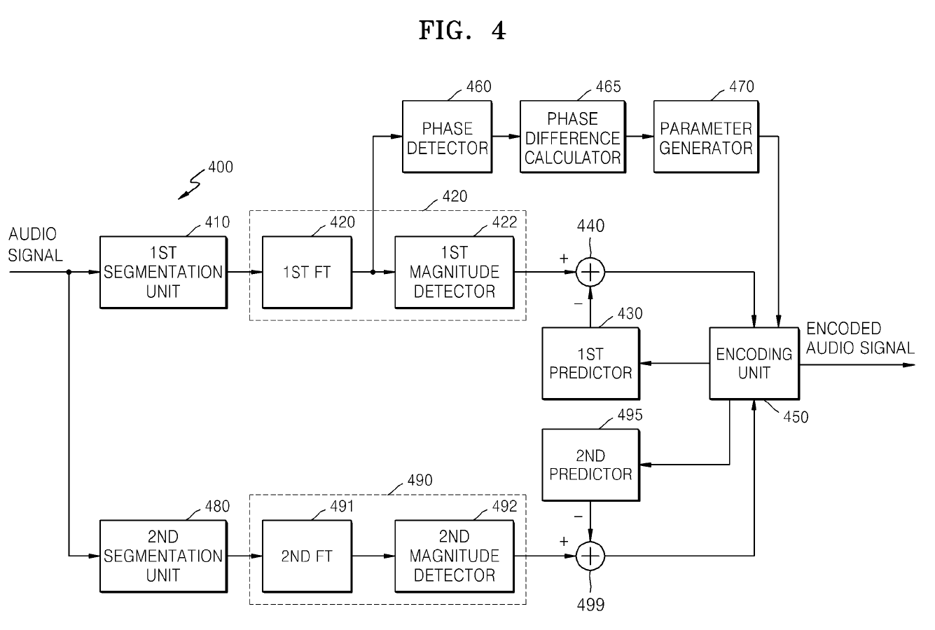

FIG. 4 is a functional block diagram illustrating an audio encoding apparatus 400 according to another exemplary embodiment of the present invention.

Referring to FIG. 4, the audio encoding apparatus 400 includes a first segmentation unit 410, a first magnitude detection unit 420, a first predictor 430, a first detector 440, an encoding unit 450, a phase detector 460, a phase difference calculator 465, a parameter generator 470, a second segmentation unit 480, a second magnitude detection unit 490, a second predictor 495, and a second detector 499.

The first segmentation unit 410, the first magnitude detection unit 420, the second segmentation unit 480, the second magnitude detection unit 490, the phase detector 460, the phase difference calculator 465, and the parameter generator 470 illustrated in FIG. 4 are constructed and operate in a manner similar to that of the first segmentation unit 310, the first magnitude detection unit 320, the second segmentation unit 330, the second magnitude detection unit 340, the phase detector 350, the phase difference detector 360, and the parameter generator 370, respectively, illustrated in FIG. 3.

The first predictor 430 predicts at least one magnitude of a current short frame based on at least one magnitude of the previous short frame provided by the encoding unit 450. In the current exemplary embodiment, the first predictor 430 predicts N/2 magnitudes of the current short frame, based on N/2 magnitudes of the previous short frame.

The first detector 440 determines the difference between the at least one magnitude (or N/2 magnitudes) output from the first magnitude detection unit 420 and the at least one predicted magnitude (or N/2 predicted magnitudes) output from the first predictor 430. The detected difference is transmitted to the encoding unit 450.

The second predictor 495 predicts at least one magnitude of a current long frame based on at least one magnitude of the previous long frame provided by the encoding unit 450. In this exemplary embodiment, the second predictor 495 predicts N/2 magnitudes of the current long frame, based on N/2 magnitudes of the previous long frame.

The second detector 499 determines the difference between the at least one magnitude (or N/2 magnitudes) of the long frame output from the second magnitude detection unit 490 and the at least one predicted magnitude (or N/2 predicted magnitudes) of the long frame output from the second predictor 495. The detected difference is transmitted to the encoding unit 450.

The encoding unit 450 encodes the differences output from the first detector 440, and the second detector 499, respectively, and the parameter output from the parameter generator 470, and outputs the result of encoding as an encoded audio signal. The output encoded audio signal may be in the form of a bitstream.

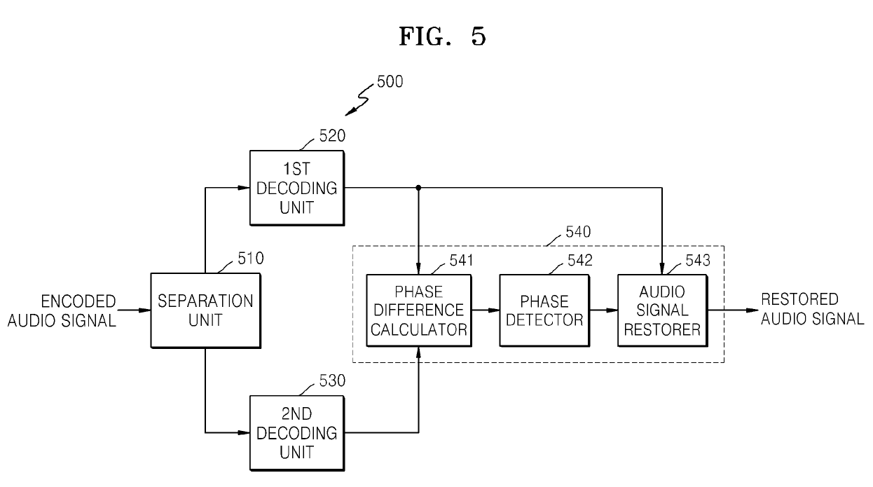

FIG. 5 is a functional block diagram illustrating an audio decoding apparatus 500 according to an exemplary embodiment of the present invention. Referring to FIG. 5, the audio decoding apparatus 500 includes a separation unit 510, a first decoding unit 520, a second decoding unit 530, and a restoration unit 540.

If an encoded audio signal is received, the separation unit 510 separates at least one encoded magnitude in relation to each frame having a different length, based on the frame length. That is, the separation unit 510 transmits at least one encoded magnitude of a short frame included in the encoded audio signal, to the first decoding unit 520, and transmits at least one encoded magnitude of a long frame included in the encoded audio signal, to the second decoding unit 530. The encoding audio signal may be in the form of a bitstream. The short frame and the long frame are frames that have the same relationship as that illustrated in FIG. 2.

FIG. 5 illustrates an audio decoding apparatus corresponding to the audio encoding apparatus illustrated in FIG. 1. Accordingly, the number of the at least one encoded magnitude of the short frame may be N/2 and the number of the at least one encoded magnitude of the long frame may be N/2.

The first decoding unit 520 decodes at least one magnitude of the short frame, separated by the separation unit 510. The second decoding unit 530 decodes at least one magnitude of the long frame, separated by the separation unit 510. The first decoding unit 520 and the second decoding unit 530 decode the input magnitudes by using a decoding method corresponding to the encoding unit 150 included in the audio encoding apparatus 100 illustrated in FIG. 1.

The restoration unit 540 restores an audio signal, by using at least one decoded magnitude (r_{ω}) of a short frame and at least one decoded magnitude (\tilde{r}_{ω}) of a previous short frame output from the first decoding unit 520, and at least one decoded magnitude (R_{2ω}) of a long frame output from the second decoding unit 530.

For this, the restoration unit 540 includes a phase difference calculator 541, a phase detector 542, and an audio signal restorer 543.

The phase difference calculator 541 calculates the input magnitudes, including the at least one decoded magnitude (r_{ω}) of the short frame, the at least one decoded magnitude (\tilde{r}_{ω}) of the previous short frame, and the at least one decoded magnitude (R_{2ω}) of the long frame as defined by equation 8 below, thereby calculating the phase difference (φ_{ω}−\tilde{φ}_{ω}) between the current short frame and the previous short frame:

φ_{ω}−\tilde{φ}_{ω=cos}⁻¹ [(R_{2ω}²−r_{ω}²−\tilde{r}_{ω}²)/(2r_{ω}\tilde{r}_{ω})] (8)

Equation 8 can be derived by squaring the left sides and the right sides, respectively, of equation 6, and adding the squared left sides, and the squared right sides, respectively. If solutions of equation 8 are obtained in the range −π<φ_{ω}−\tilde{φ}_{ω}<π, 2 solutions having opposite signs are obtained. The reason is that a cosine function is symmetrical. In order to obtain a correct solution from the two solutions, a parameter indicating the sign of a phase difference transmitted by an audio encoding apparatus can be used.

The phase detector 542 determines the phase (φ) of the current short frame based on the phase difference detected by the phase difference calculator 541. That is, the phase (φ) of the current short frame can be detected according to equation 9 below:

φ=cos⁻¹(R_{2ω}²−r_{ω}²−\tilde{r}_{ω}²)/(2r_{ω}\tilde{r}_{ω})+\tilde{φ}_{ω} (9)

The audio signal restoration unit 543 restores an audio signal, by using the phase (φ) of the current short frame and the magnitude of the current short frame provided by the first decoding unit 520. That is, the Fourier transform coefficients a_{ω} and b_{ω} of the short frame, described above, can be redefined as equation 10 below, by using the magnitude (r_{ω}) of the short frame and the phase (φ) of the short frame:

a_{ω}=r_{ω} cos φ

b_{ω}=r_{ω} sin φ (10)

If equation 10 is substituted into equation 1, the audio signal of the short frame can be redefined as equation 11 below:

$${S}_{short} = {\sum }_{ω = 0}^{N / 2 - 1} ( {r}_{ω} cos {ϕ}_{ω} cos ( ω t ) + {r}_{ω} sin {ϕ}_{ω} sin ( ω t ) ) \qquad ( 11 )$$

The audio signal restoration unit 543 restores an audio signal, by using the magnitude (r_{ω}) of the decoded short frame and the phase (φ) of the short frame detected by the phase detection unit 542 according to equation 11, and outputs the restored audio signal.

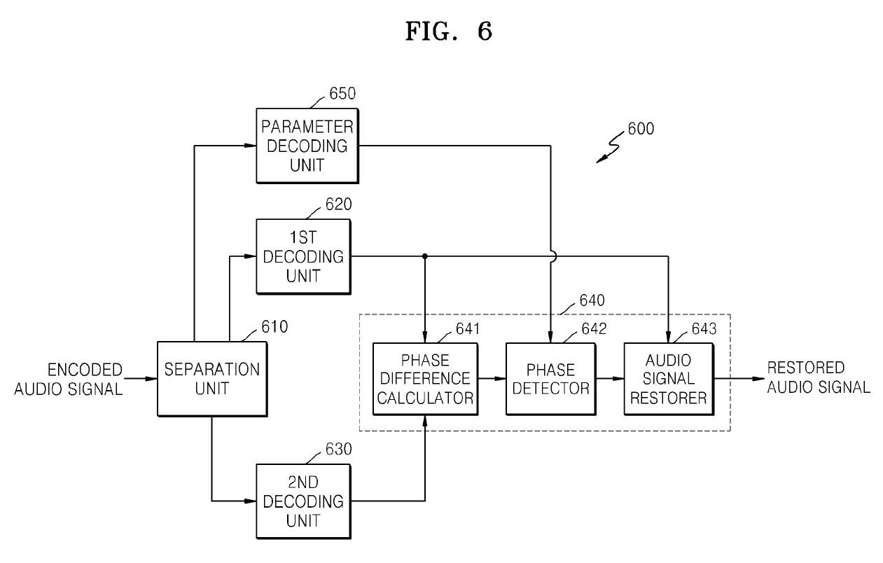

FIG. 6 is a functional block diagram illustrating an audio decoding apparatus 600 according to another exemplary embodiment of the present invention. The audio decoding apparatus 600 illustrated in FIG. 6 corresponds to the audio encoding apparatus 300 illustrated in FIG. 3.

Referring to FIG. 6, the audio decoding apparatus 600 includes a separation unit 610, a first decoding unit 620, a second decoding unit 630, a restoration unit 640, and a parameter decoding unit 650. The first decoding unit 620, the second decoding unit 630, and the restoration unit 640 illustrated in FIG. 6 are constructed and operate in a manner similar to that of the first decoding unit 520, the second decoding unit 530, and the restoration unit 540, respectively, illustrated in FIG. 5. Accordingly, a phase difference calculator 641, a phase detector 642, and an audio signal restorer 643 illustrated in FIG. 6 are constructed and operate in a manner similar to that of the phase difference calculator 541, the phase detector 542, and the audio signal restorer 543, respectively, illustrated in FIG. 5.

The separation unit 610 separates at least one encoded magnitude of a short frame, at least one encoded magnitude of a long frame, and an encoded parameter transmitted together, respectively. The parameter indicates whether the phase difference between the current short frame and the previous short frame is a negative. Accordingly, the at least one encoded magnitude of the short frame is transmitted to the first decoding unit 620, the at least one encoded magnitude of the long frame is transmitted to the second decoding unit 630, and the encoded parameter is transmitted to the parameter decoding unit 650.

The parameter decoding unit 650 decodes the encoded parameter transmitted by the separation unit 610. The decoded parameter is transmitted to the phase detector 642.

The phase detector 642 determines the phase of the current short frame in the same manners as the phase detector 542 illustrated in FIG. 5. In this case, the detected phase may have a positive or negative value. For example, if the parameter indicates a negative, the phase detector 642 determines a phase having a negative phase value. If the parameter does not indicate a negative, the phase detector 642 determines a phase having a positive phase value.

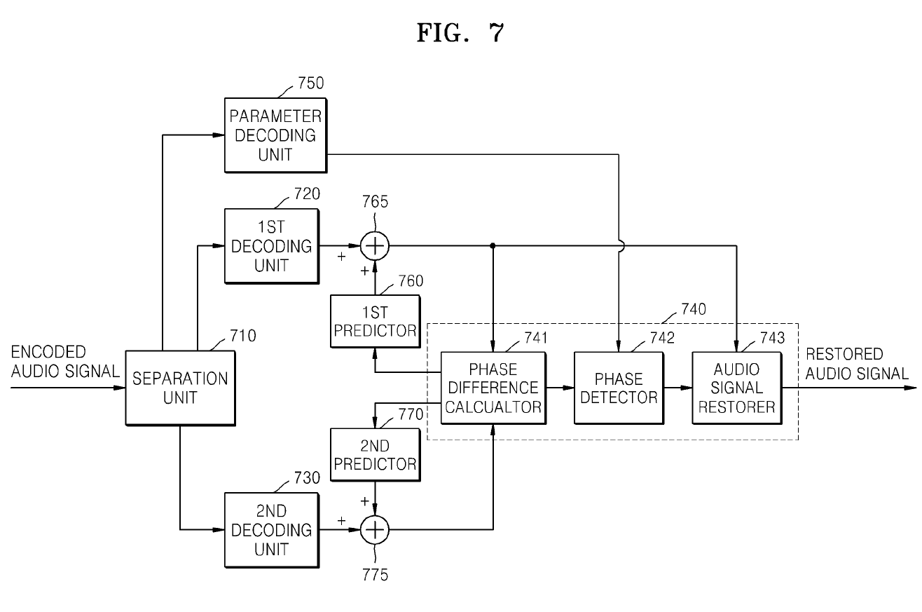

FIG. 7 is a functional block diagram illustrating an audio decoding apparatus 700 according to another exemplary embodiment of the present invention. The audio decoding apparatus 700 illustrated in FIG. 7 corresponds the audio encoding apparatus 400 illustrated in FIG. 4. Referring to FIG. 7, the audio decoding apparatus 700 includes a separation unit 710, a first decoding unit 720, a second decoding unit 730, a restoration unit 740, a parameter decoding unit 750, a first predictor 760, a first adder 765, a second predictor 770, and a second adder 775.

The separation unit 710, the first decoding unit 720, the second decoding unit 730, and the parameter decoding unit 750 illustrated in FIG. 7 are constructed and operate in a manner similar to that of the separation unit 610, the first decoding unit 620, the second decoding unit 630, and the parameter decoding unit 650, respectively, illustrated in FIG. 6.

The restoration unit 740 is constructed and operates in a manner similar to that of the restoration unit 640 illustrated in FIG. 6, except that in the restoration unit 740, a phase difference calculator 741 transmits at least one magnitude of a previous short frame and at least one magnitude of a previous long frame, to a first predictor 760 and a second predictor 770, respectively.

The first predictor 760 predicts at least one magnitude of a current short frame, based on the at least one magnitude of the previous short frame transmitted by the phase difference calculator 741. The first adder 765 adds the at least one predicted magnitude transmitted by the first predictor 760 to the at least one decoded magnitude of the short frame output from the first decoding unit 720, and transmits the addition result to the phase difference calculator 741 and an audio signal restorer 743.

The second predictor 770 predicts at least one magnitude of a current long frame, based on the at least one magnitude of the previous long frame transmitted by the phase difference calculator 741. The second adder 775 adds the at least one predicted magnitude transmitted by the second predictor 770 to the at least one decoded magnitude of the long frame output from the second decoding unit 730, and transmits the addition result to the phase difference calculator 741.

The phase difference calculator 741 treats the addition result transmitted by the first adder 765, as the magnitude of the current short frame, and the addition result transmitted by the second adder 775, as the magnitude of the current long frame, thereby calculating the phase difference between the phase of the previous short frame and the phase of the current short frame.

The phase detector 742 and the audio signal restorer 743 are constructed and operate in a manner similar to that of the phase detector 642 and the audio signal restorer 643, respectively, illustrated in FIG. 6.

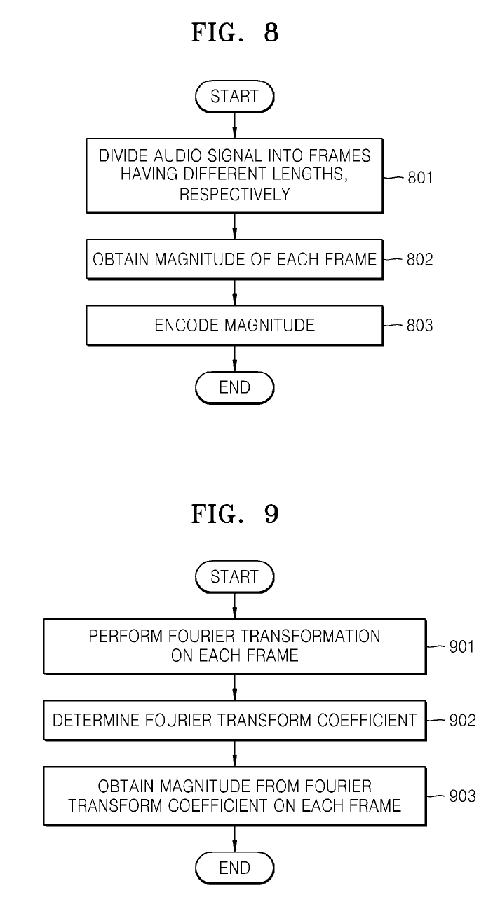

FIG. 8 is a flowchart illustrating an audio encoding method according to an exemplary embodiment of the present invention. Referring to FIG. 8, in the audio encoding method, an input audio signal is divided into frames each having a different length in operation 801. That is, as in the first segmentation unit 110 and the second segmentation unit 130 illustrated in FIG. 1, the input audio signal is divided into short frames and long frames. The length of the long frame is twice the length of the short frame, and the contents of the long frame correspond to the contents of the current frame and previous frame of the short frame, as illustrated in FIG. 2.

In operation 802, at least one magnitude of each of the frames having different lengths is obtained. That is, as in the first magnitude detection unit 120 and the second magnitude detection unit 140 illustrated in FIG. 1, at least one magnitude of the short frame and at least one magnitude of the long frame are obtained.

Operation 802 may be performed as illustrated in FIG. 9. FIG. 9 is a detailed flowchart of the process of obtaining the magnitude of each frame illustrated in FIG. 8 according to an exemplary embodiment of the present invention. Referring to FIG. 9, as in the first FT 121 and the second FT 141 illustrated in FIG. 1, each of the short frame and the long frame is Fourier transformed in operation 901. Fourier transform coefficients a_{ω} and b_{ω} are calculated from the Fourier transformed short frame signal and long frame signal, respectively, in operation 902. Then, at least one magnitude is obtained from the detected Fourier transform coefficients a_{ω} and b_{ω} in operation 903. In the current exemplary embodiment, N/2 magnitudes of each of the short frame and the long frame are obtained, and the number N corresponds to the length of the short frame. The N/2 magnitudes of the long frame correspond to the magnitude of an even frequency.

If at least one magnitude of each frame is obtained in operation 802, the obtained magnitude of each frame is encoded in operation 803 according to the audio encoding method illustrated in FIG. 8. That is, as in the encoding unit 150 illustrated in FIG. 1, the input magnitudes, including the at least one magnitude of the short frame and the at least one magnitude of the long frame, are encoded according to a predetermined encoding method.

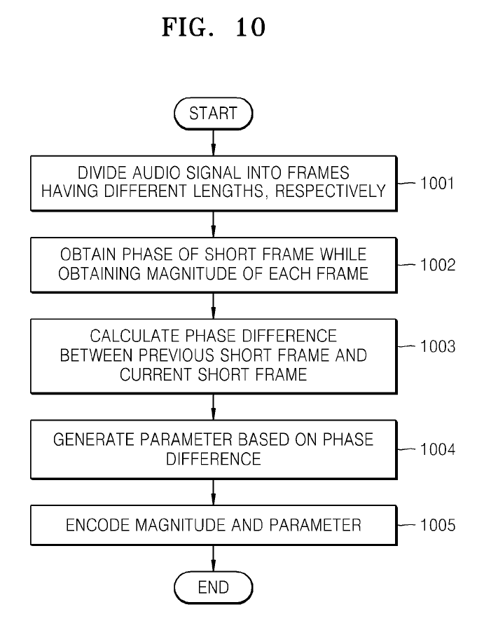

FIG. 10 is a flowchart illustrating an audio encoding method according to another exemplary embodiment of the present invention. FIG. 10 illustrates a case in which a function of encoding a parameter in relation to the phase difference between a current short frame and the previous short frame is added to the audio encoding method illustrated in FIG. 8. Accordingly, operation 1001 illustrated in FIG. 10 is performed in a manner similar to that of operation 801 illustrated in FIG. 8.

Then, according to the audio encoding method of the current exemplary embodiment, the phase of the short frame is obtained, while obtaining at least one magnitude of each of the short frame and the long frame, in operation 1002. The phase of the short frame is obtained in a manner similar to that performed by the phase detector 350 illustrated in FIG. 3.

In operation 1003, the phase difference between the phase obtained in operation 1002 and the phase of the previous short frame is calculated. The phase difference is calculated in a manner similar to that of the phase difference calculator 360 illustrated in FIG. 3. Then, a parameter is generated based on the phase difference in operation 1004. The parameter is generated in a manner similar to that of the parameter generator 370 illustrated in FIG. 3. The parameter indicates whether the phase difference is a negative. In operation 1005, each of the at least one magnitude of the short frame, the at least one magnitude of the long frame, obtained in operation 1002, and the parameter is encoded.

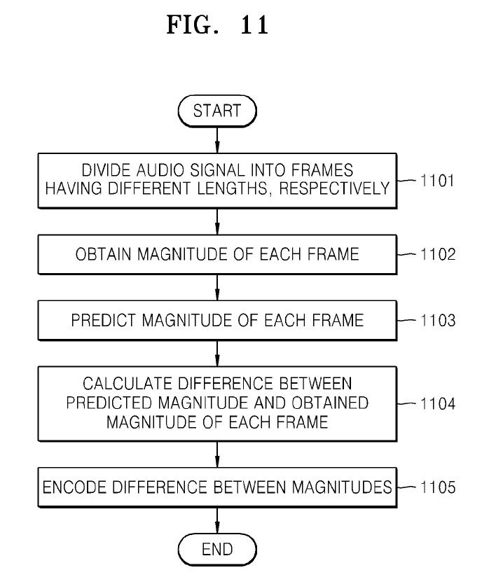

FIG. 11 is a flowchart illustrating an audio encoding method according to another exemplary embodiment of the present invention. FIG. 11 illustrates a case in which a function of prediction is added to the audio encoding method illustrated in FIG. 8. Accordingly, operations 1101 and 1102 illustrated in FIG. 11 are performed in a manner similar to that of operations 801 and 802, respectively, illustrated in FIG. 8.

According to the audio encoding method illustrated in FIG. 11, if at least one magnitude of each of a short frame and a long frame is obtained, at least one magnitude of a current short frame is predicted based on at least one magnitude of the previous short frame, and at least one magnitude of a current long frame is predicted based on at least one magnitude of the previous long frame in operation 1103. Then, the difference between the at least one predicted magnitude of the current short frame and the at least one magnitude of the short frame obtained in operation 1102, is calculated, and the difference between the at least one predicted magnitude of the current long frame and the at least one magnitude of the long frame obtained in operation 1102, is calculated in operation 1104. The detected difference between the magnitudes of the short frames and the detected difference between the magnitudes of the long frames are encoded in operation 11105.

The audio encoding method illustrated in FIG. 11 can be applied to the audio encoding method illustrated in FIG. 10. That is, instead of operation 1005 for encoding the magnitude of each of the short frame and the long frame obtained in operation 1002 illustrated in FIG. 10, the audio encoding method may be implemented so that the difference between the predicted magnitudes can be encoded.

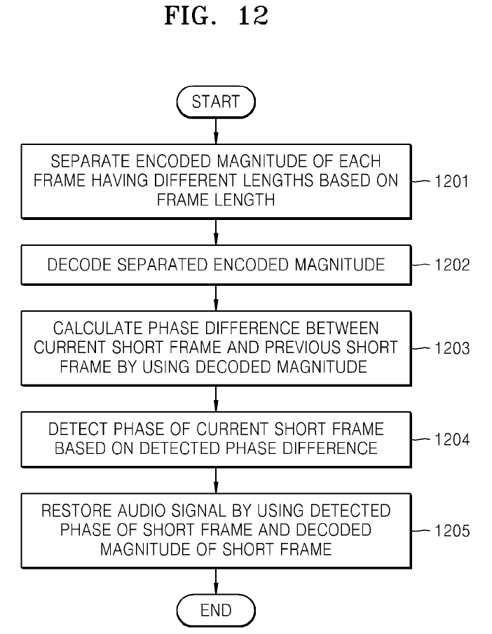

FIG. 12 is a flowchart illustrating an audio decoding method according to an exemplary embodiment of the present invention. Referring to FIG. 12, at least one encoded magnitude in relation to each frame having a different length is separated based on the frame length, in the same manner as performed by the separation unit 510 illustrated in FIG. 5, in operation 1201.

Then, each of the separated encoded magnitudes is decoded in operation 1202. That is, the at least one separated magnitude of the short frame is decoded, and the at least one separated magnitude of the long frame is decoded. Next, by using the decoded magnitudes, the phase difference between the current short frame and the previous short frame is calculated in operation 1203. The phase difference is calculated in a manner similar to that performed by the phase difference detector 541 illustrated in FIG. 5.

Then, based on the calculated phase difference, the phase of the current short frame is detected in operation 1204. The phase of the current short frame is detected in a manner similar to that performed by the phase detector 542 illustrated in FIG. 5. By using the detected phase of the short frame and the magnitude of the short frame decoded in operation 1202, an audio signal is restored in operation 1205. The audio signal is restored in a manner similar to that performed by the audio signal restorer 543 illustrated in FIG. 5.

Operations 1203 through 1205 may be defined as operations for restoring an audio signal.

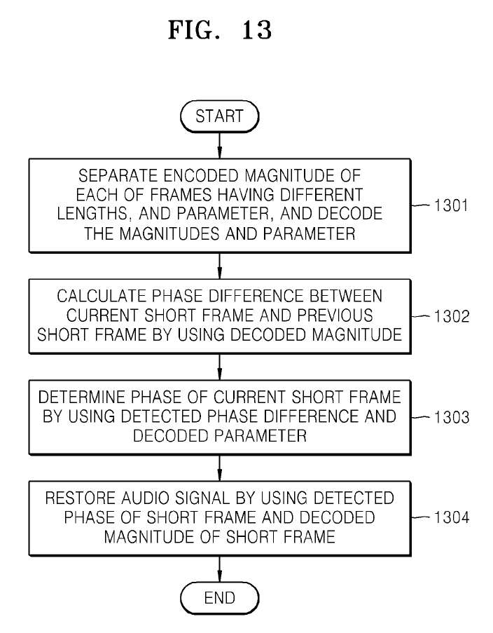

FIG. 13 is a flowchart illustrating an audio decoding method according to another exemplary embodiment of the present invention. FIG. 13 illustrates a case in which an audio decoding function using a parameter is added to the audio decoding method illustrated in FIG. 12.

That is, at least one encoded magnitude of each frame having a different length and a parameter are separated based on the frame length in a manner similar to that performed by the separation unit 610 illustrated in FIG. 6, and each of the at least one separated magnitude of the short frame, the at least one separated magnitude of the long frame, and the parameter is decoded in operation 1301.

Next, by using the decoded magnitude, the phase difference between the current short frame and the previous short frame is calculated as in the phase difference calculator 641 illustrated in FIG. 6, in operation 1302. According to the audio decoding method illustrated in FIG. 13, by using the calculated phase difference and the decoded parameter, the phase of the current short frame is detected in operation 1303. That is, the phase of the current short frame is detected in a manner similar to that performed by the phase detector 642 illustrated in FIG. 6.

By using the phase of the short frame detected in operation 1303, and the magnitude of the short frame decoded in operation 1301, an audio signal is restored in a manner similar to that performed by the audio restorer illustrated in FIG. 6, in operation 1304.

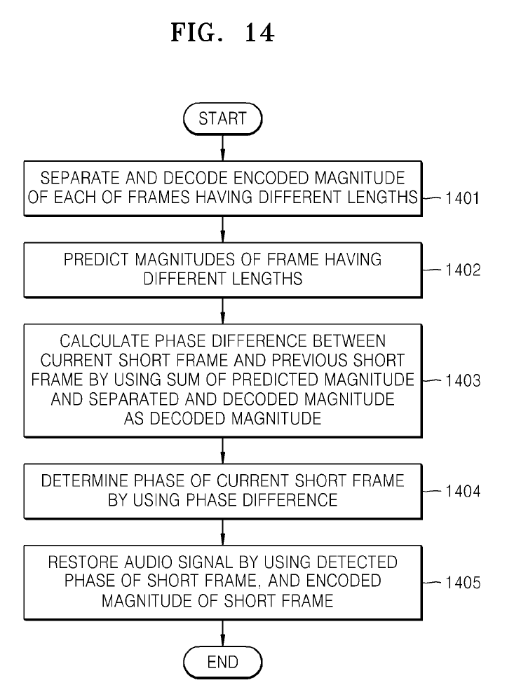

FIG. 14 is a flowchart illustrating an audio decoding method according to another exemplary embodiment of the present invention. FIG. 14 illustrates a case in which a prediction function is further included in the audio decoding method illustrated in FIG. 12.

Referring to FIG. 14, at least one encoded magnitude of each frame having a different length is separated based on the frame length, and decoded in operation 1401. Then, the magnitude of the frame having a different length is predicted in operation 1402. That is, in operation 1402, at least one magnitude of the short frame and at least one magnitude of the long frame are predicted. The prediction method is performed in a manner similar to that performed by the first predictor 760 and the second predictor 770 illustrated in FIG. 7.

By using the sum of the predicted magnitude and the decoded magnitude as a decoded magnitude, the phase difference between the current short frame and the previous short frame is calculated in operation 1403. That is, as in the phase difference calculator 741 illustrated in FIG. 7, the sum of the predicted magnitude of the short frame and the decoded magnitude of the short frame is used as the decoded magnitude of the short frame, and the sum of the predicted magnitude of the long frame and the decoded magnitude of the long frame is used as the decoded magnitude of the long frame, thereby calculating the phase difference between the current short frame and the previous short frame.

In operation 1404, by using the calculated phase difference, the phase of the current short frame is detected. That is, the phase of the current short frame is detected in a manner similar to that performed by the phase detector 742 illustrated in FIG. 7.

By using the phase of the short frame detected in operation 1404 and the magnitude of the short frame decoded in operation 1401, an audio signal is restored in a manner similar to that performed by the audio restorer 743 illustrated in FIG. 7, in operation 1404.

The audio decoding method illustrated in FIG. 14 may be modified by combining it with the audio decoding method illustrated in FIG. 13. That is, the audio decoding method illustrated in FIG. 14 can be modified so that the audio decoding function using the parameter illustrated in FIG. 13 can be added to the audio decoding method illustrated in FIG. 14. If the method illustrated in FIG. 14 is modified as such, operation 1401 may further include a function of separating and decoding a parameter, and operation 1404 may further include using the decoded parameter when the phase of the short frame is detected as described above. That is, by using the calculated phase difference and the decoded parameter, the phase of the current short frame can be detected.

According to the present invention as described above, by encoding the magnitude of a frame having a different length detected from an input audio signal, compression efficiency can be enhanced in entropy coding, and furthermore, efficient prediction can be achieved. This is because the magnitude of a frequency component has a characteristic in that the magnitude varies negligibly with respect to time and frequency.

The present invention can also be embodied as computer readable codes on a computer readable recording medium. The computer readable recording medium is any data storage device that can store data which can be thereafter read by a computer system. Examples of the computer readable recording medium include, but not limited to, read-only memory (ROM), random-access memory (RAM), CD-ROMs, magnetic tapes, floppy disks, and optical data storage devices The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An audio encoding method comprising:
dividing an input audio signal into frames having lengths different from each other;
obtaining at least one magnitude in relation to each of the frames having different lengths; and
encoding the magnitude.

2. The method of claim 1, wherein the dividing the input audio signal comprises dividing the input audio signal so that a length of a long frame is twice a length of a short frame, and contents of the long frame correspond to contents of a current frame and a previous short frame.

3. The method of claim 2, wherein the obtaining the at least one magnitude in relation to each of the frames comprises:
performing Fourier transformation on each of the frames having different lengths;
determining a Fourier transform coefficient from the Fourier transformed signal; and
obtaining the at least one magnitude from the Fourier transform coefficients.

4. The method of claim 3, wherein in the obtaining the at least one magnitude from the Fourier transform coefficients, N/2 magnitudes of each of the frames having different lengths are obtained and N is the length of the short frame.

5. The method of claim 4, wherein N/2 magnitudes of the long frame determined in the obtaining of the at least one magnitude are the magnitudes of an even frequency.

6. The method of claim 3, further comprising:
obtaining phase of a short frame from among the frames having different lengths;
calculating a phase difference between the phase of the short frame and a phase of the previous short frame;
generating a parameter based on the phase difference; and
encoding the parameter,
wherein the parameter indicates whether the phase difference is negative.

7. The method of claim 1, further comprising:
predicting at least one magnitude of each of the frames having different lengths; and
determining a difference between the at least one predicted magnitude and the at least one obtained magnitude,
wherein in the encoding the magnitude, the difference between the magnitudes is encoded.

8. An audio decoding method comprising:
separating at least one encoded magnitude in relation to each of frames having different lengths, based on the frame length;
decoding each of the separated encoded magnitudes; and
restoring an audio signal based on the decoded magnitude

9. The method of claim 8, wherein the restoring of the audio signal comprises:
calculating a phase difference between a current short frame and a previous short frame of the short frame from among the frames having different lengths;
determining a phase of the current short frame based on the calculated phase difference; and
restoring the audio signal based on the phase of the current short frame and the decoded magnitude of the short frame.

10. The method of claim 9, further comprising decoding a parameter received together with the encoded magnitude of each of the frames having different lengths,
wherein in the determining the phase of the current short frame, the phase of the current short frame is detected based on the decoded parameter, and the parameter indicates whether the phase difference between the current short frame and the previous short frame is negative.

11. The method of claim 9, further comprising predicting at least one magnitude of each of the frames having different lengths,
wherein the phase difference between the current short frame and the previous short frame is calculated by using a sum of the at least one predicted magnitude of each of the frames and the decoded magnitude of each of the frames having different lengths, as the decoded magnitude.

12. An audio encoding apparatus comprising:
a first segmentation unit which divides an input audio signal into short frames;
a first magnitude detection unit which obtains at least one magnitude of a short frame output from the first segmentation unit;
a second segmentation unit which divides the input audio signal into long frames;
a second magnitude detection unit which obtains at least one magnitude of a long frame output from the second segmentation unit; and
an encoding unit which encodes the magnitudes detected by the first magnitude detection unit and the second magnitude detection unit,
wherein a length of the short frame is different from a length of the long frame.

13. The apparatus of claim 12, wherein the length of a long frame is twice the length of the short frame, and contents of the long frame correspond to contents of a current short frame and a previous short frame of the short frame.

14. The apparatus of claim 12, wherein the first magnitude detection unit comprises:
a first Fourier transform unit which performs Fourier transformation on a signal of the short frame; and
a first magnitude detector which determines a Fourier transform coefficient from the Fourier transformed signal output from the first Fourier transform unit, and determining the at least one magnitude from the detected Fourier transform coefficient, and
the second magnitude detection unit comprises:
a second Fourier transform unit which performs Fourier transformation on a signal of the long frame; and
a second magnitude detector which determines a Fourier transform coefficient from the Fourier transformed signal output from the second Fourier transform unit, and determining the at least one magnitude from the detected Fourier transform coefficient.

15. The apparatus of claim 13, wherein the first magnitude detector and the second magnitude detector obtain N/2 magnitudes of the short frame and the long frame, respectively, and N is the length of the short frame.

16. The apparatus of claim 15, wherein the N/2 magnitudes of the long frame are the magnitudes of an even frequency.

17. The apparatus of claim 14, further comprising:
a phase detector which determines a phase of the short frame;
a phase difference calculator calculating a phase difference between the determined phase and a phase of a previous short frame; and
a parameter generator which generates a parameter based on the phase difference,
wherein the encoding unit further encodes the parameter, and the parameter indicates whether the phase difference is negative.

18. The apparatus of claim 17, further comprising:
a first predictor which predicts at least one magnitude of the short frame;
a first detector which determines a difference between the at least one predicted magnitude output from the first predictor and the magnitude determined by the first magnitude detection unit, and transmitting the difference to the encoding unit;
a second predictor which predicts at least one magnitude of the long frame;
a second detector which determines a difference between the at least one magnitude predicted in the second predictor and the magnitude determined by the second magnitude detection unit, and transmitting the difference to the encoding unit.

19. The apparatus of claim 12, further comprising:
a first predictor which predicta at least one magnitude of the short frame;
a first detector which determines a difference between the at least one magnitude predicted from the first predictor and the magnitude detected by the first magnitude detection unit, and transmitting the difference to the encoding unit;
a second predictor which predicts at least one magnitude of the long frame;
a second detector which determines a difference between the at least one magnitude predicted in the second predictor and the magnitude detected by the second magnitude detection unit, and transmitting the difference to the encoding unit.

20. An audio decoding apparatus comprising:
a separation unit which separates at least one encoded magnitude of each of frames having different lengths, based on a frame length;
a first decoding unit which decodes a magnitude of a short frame separated by the separation unit;
a second decoding unit which decodes a magnitude of a long frame separated by the separation unit; and
a restoration unit which restores an audio signal, based on the magnitude of the short frame decoded in the first decoding unit and the magnitude of the long frame decoded in the second decoding unit.

21. The apparatus of claim 20, wherein the restoration unit comprises:
a phase difference calculator which calculates a phase difference between a current short frame and a previous short frame, based on the decoded magnitude of the short frame, the decoded magnitude of the long frame, and a decoded magnitude of the previous short frame;
a phase detector which determines a the phase of the current short frame based on the phase difference; and
an audio signal restorer which restores the audio signal based on the phase of the current short frame and the magnitude of the short frame decoded in the first decoding unit.

22. The apparatus of claim 21, wherein the separation unit separates a parameter which is received together with the encoded magnitude, and
the audio decoding apparatus further comprises a parameter decoding unit which decodes the parameter, and
the phase detector which determines the phase of the current short frame based on further the decoded parameter, and
the parameter indicates whether the phase difference between the current short frame and the previous short frame is negative.

23. The apparatus of claim 21, further comprising:
a first predictor which predicts at least one magnitude of the short frame;
a first adder which obtains a first sum of the magnitude predicted in the first predictor and the magnitude decoded in the first decoding unit;
a second predictor which predicts at least one magnitude of the long frame; and
a second adder which obtains a second sum of the magnitude predicted in the second predictor and the magnitude decoded in the second decoding unit,
wherein the phase difference calculator calculates the phase difference, based on the first sum and the second sum.
